(19) United States
(12) Patent Application Publication
(10) Pub. No.: US 2019/0139006 A1
(43) Pub. Date: May 9, 2019

(54) CHARITABLE GIFTING SYSTEM AND METHOD OF USE

(71) Applicant: John Tyler Piazza, Arlington, TX (US)

(72) Inventor: John Tyler Piazza, Arlington, TX (US)

(21) Appl. No.: 16/179,931

(22) Filed: Nov. 3, 2018

Related U.S. Application Data
(60) Provisional application No. 62/581,519, filed on Nov. 3, 2017.

(51) Int. Cl. G06Q 20/04; G06Q 20/32

(52) U.S. Cl. CPC G06Q 20/045; G06Q 20/3223

(57) ABSTRACT

A method of giving a charitable gift includes making a selection of one or more items from a computing device, the selection being associated with an online platform; receiving a printed receipt, the printed receipt having an identification code associated therewith; transferring the printed receipt to an individual; and providing the individual with the selection of one or more items from a brick and mortar store; the identification code is associated with the selection of one or more items.

### BACKGROUND

### 1. Field of the Invention

The present invention relates generally to charitable gifting systems, and more specifically, to a system for pre-selecting items to be given to someone in need.

### 2. Description of Related Art

Charitable gifting is a common practice and generally involves a monetary gift to someone in need. For example, people will commonly see someone in need along a road and decide to give them a monetary gift. One of the problems commonly associated with these systems is the unknown spending of the monetary gift. Many people will not give out money for fear that the money will be spent frivolously, therefore, both the person in need and the giving party do not receive benefits commonly associated with charitable gifts.

Accordingly, although great strides have been made in the area of charitable gifting, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified schematic of a charitable gifting system in accordance with a preferred embodiment of the present application;

FIG. 2 is a simplified schematic of an alternative embodiment of a charitable gifting system in accordance with the present application;

FIG. 3 is a simplified schematic of an alternative embodiment of a charitable gifting system in accordance with the present application; and

FIG. 4 is a flowchart of the method of use of the systems of FIGS. 1, 2, and 3.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional charitable gifting systems. Specifically, the present invention provides a means for a giving party to conveniently pre-select one or more items to be redeemed by a party in need. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

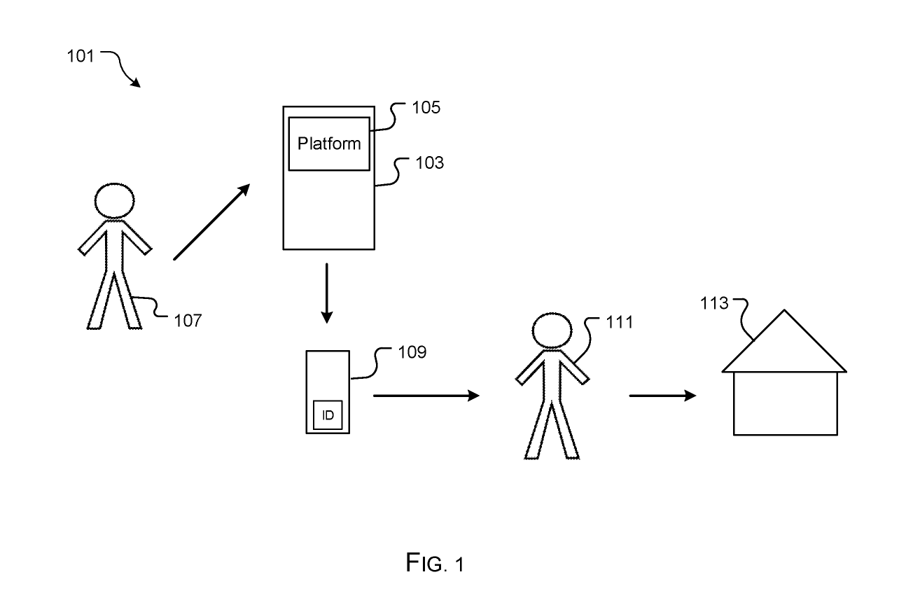

Referring now to the drawings wherein like reference characters identify corresponding or similar elements throughout the several views, FIG. 1 depicts a simplified schematic of a charitable gifting system 101 in accordance with a preferred embodiment of the present application. It will be appreciated that system 101 overcomes one or more of the above-listed problems commonly associated with conventional charitable gifting systems.

In the contemplated embodiment, system 101 includes a kiosk 103 with access to an item selection platform 105, wherein the item selection platform 105 provides a database of items to be pre-purchased by a giving party 107. It should be appreciated that kiosk 103 includes necessary components such as a power source, a display screen, a payment receiving device (such as a card reader), and a receipt printing device.

In the preferred embodiment, the giving party 107 goes to the kiosk and pulls up platform 105 to access a selection of items, wherein the giving party proceeds to select one or more items. The giving party 107 then provides payment, wherein the kiosk is configured to generate a receipt 109. Receipt 109 is associated with the selected items, and includes a means to redeem said items, such as a QR code, a barcode, an ID number, or any other identifying means to associated receipt 109 to the selected items.

Giving party 107 can then proceed to give receipt 109 to a party in need 111, wherein the receipt 109 is redeemable at a store 113.

It should be appreciated that one of the unique features believed characteristic of the present application is platform 105 providing a means for the giving party to pre-select items to give to the party in need. It should be appreciated that this feature allows for the giving party to ensure that their money is being spent on items they deem appropriate. In addition, this feature eliminates the need of the giving party to keep a plurality of items with them to hand out. Such items selected can include toiletries, food, clothing, or any other items.

It should be appreciated that kiosk 103 can be associated with a particular partnered store, or multiple partnered stores. In addition, it should be appreciated that the location of kiosk 103 can vary.

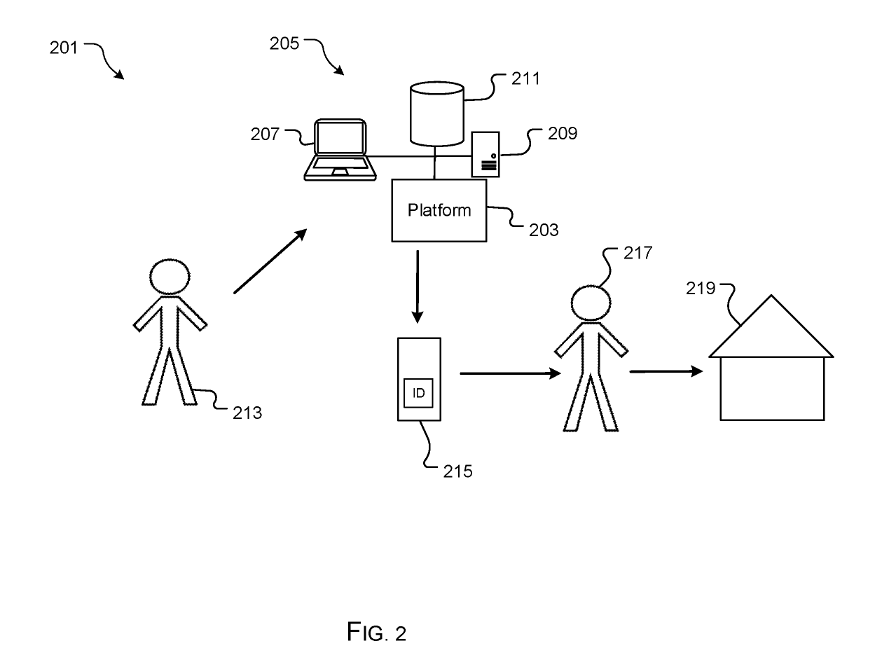

In FIG. 2, an alternative embodiment of a charitable gifting system 201 is shown. System 201 is similar in form and function to system 101. System 201 includes an item selection platform 203 configured to be operated through a network 205 having one or more of a computer 207, a server 209, and a database 211. In this embodiment, the giving party 213 can create a receipt 215 via computing device 207. It should be appreciated that computing device 207 can be a personal computer, a computer associated with a business, or any other such computing device. Similar to system 101, receipt 215 is given to a party in need 217 to be redeemed at a store 219.

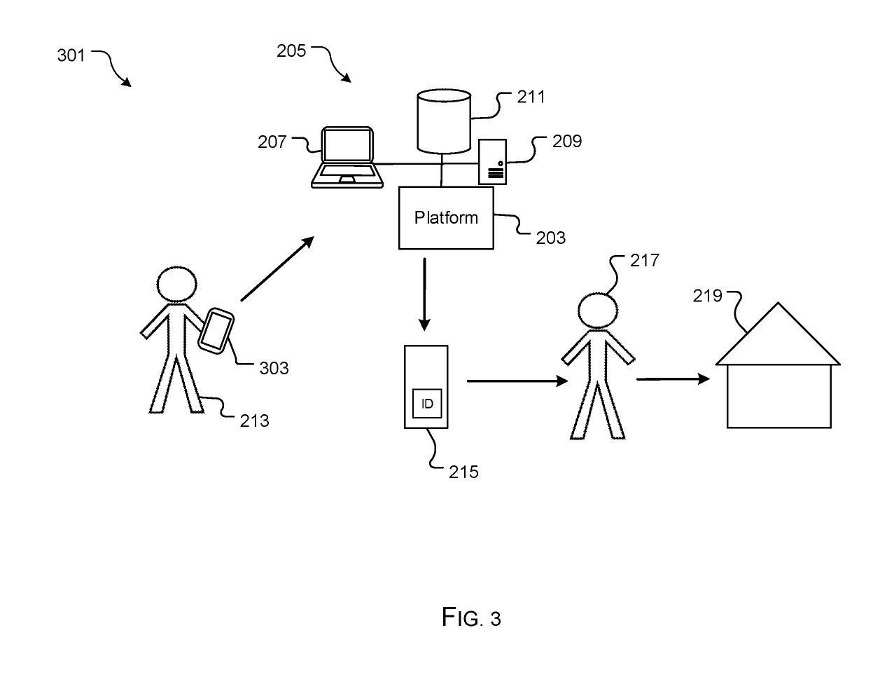

In FIG. 3, another alternative embodiment of a charitable gifting system 301 is shown. System 301 includes all of the features of system 201, and further includes a mobile device 303 configured to provide access to platform 203 via a mobile application. In this embodiment, the giving party can select items through the mobile application to generate receipt 215.

Various features are contemplated to be incorporated into the platform and/or the mobile application. Such features include the ability to create a set-list of items, to allow the giving party to create one or more set-lists for re-purchase. In addition, it is contemplated that instead of the giving party selecting exact items, the giving party can select one or more price tiers and/or item groups, wherein the party in need can then maintain autonomy by selecting their choice of item within the item group or price tier.

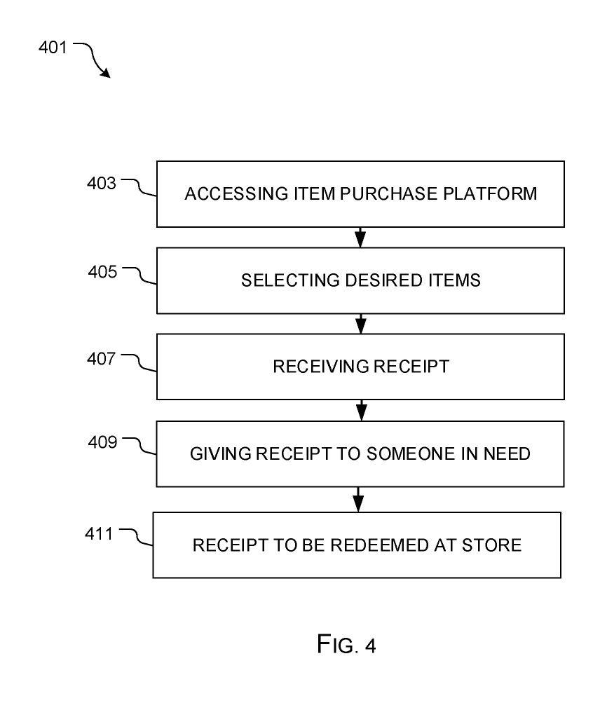

In FIG. 4, a flowchart 401 depicts the method of use associated with systems 101, 201, and 301. The giving party accesses the item selection platform to select desired items, such as toiletries, food, and clothing, as shown with boxes 403, 405. The giving party receives the receipt, having a redeemable code therein, as shown with box 407. The giving party can then proceed to give the receipt to a party in need, as shown with box 409. The giving party can then proceed to redeem the receipt at a designated store, to receive the pre-selected items, as shown with box 411.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A method of giving a charitable gift, the method comprising:
making a selection of one or more items from a kiosk, the selection being associated with an online platform;
receiving a printed receipt from the kiosk, the printed receipt having an identification code associated therewith;
transferring the printed receipt to an individual; and
providing the individual with the selection of one or more items from a brick and mortar store;
wherein the identification code is associated with the selection of one or more items.

2. A method of giving a charitable gift, the method comprising:
making a selection of one or more items from a computing device, the selection being associated with an online platform;
receiving a printed receipt, the printed receipt having an identification code associated therewith;
transferring the printed receipt to an individual; and
providing the individual with the selection of one or more items from a brick and mortar store;
wherein the identification code is associated with the selection of one or more items.

3. The method of claim 2, wherein the computing device is a mobile phone.
